(19) United States
(12) Patent Application Publication
(10) Pub. No.: US 2019/0018156 A1
(43) Pub. Date: Jan. 17, 2019

(54) Highly accurate focal mechanism for microseismic envents

(71) Applicant: The United State of America, as represented by the Secretary of the Department of the Interior, Washington, DC (US)

(72) Inventor: David Shelly, Menlo Park, CA (US)

(73) Assignee: The United State of America, as represented by the Secretary of the Department of the Interior, Washington, DC (US)

(21) Appl. No.: 15/646,090

(22) Filed: Jul. 11, 2017

(51) Int. Cl. G01V 1/30; G01V 1/28

(52) U.S. Cl. CPC G01V 1/302; G01V 1/288

(57) ABSTRACT

The present invention is a method of refining data in fault line models to produce improved focal mechanisms for small seismic events. The invention can be used for monitoring the polarity of small seismic events in real-time (e.g., fracking) as well for interpreting catalogues of past seismic events. The invention transforms ground velocity signals into vectors through a cross correlation function. The values from these vectors are weighted and ranked. The result is input into a 3-D model to enhance interpretation of seismic events and associated faulting geometry.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of seismic event measurement and, more specifically, to a method for detecting the direction of seismic events.

### BACKGROUND OF THE INVENTION

The U.S. Geological Survey (USGS) studies the environmental impact of hydraulic fracturing and conducts research to produce advanced seismic monitoring systems which can detect increasingly small seismic events and provide valuable information about the earth.

Hydraulic fracturing is a well-stimulation technique that increases production by pumping hydraulic fluid into a wellbore at pressures and injection rates based on initial injection rate and equipment parameters sufficient to fracture rock. During the fracturing operation, the project parameters are adjusted to control the orientation and other attributes of the fracture.

During the operation, computer systems monitor small seismic events that occur in multiple locations coincident to the hydraulic fracturing operation. Advanced computer systems known in the art are able to monitor small seismic events in real time. The occurrence of these events is correlated to draw conclusions about the orientation of the fracture.

One of the more advanced monitoring systems known in the art is the StimMAP™ Hydraulic Fracture Mapping Service. This system displays microseismic activity data from multiple locations in real-time during a hydraulic fracturing operation. This data is used to adjust project parameters to better control the fracture geometry and improve drilling efficiency.

StimMAP™ and other systems known in the art are able to accurately and rapidly detect patterns of small seismic events, as well as their magnitude. However, these systems can not disclose the orientation of the individual fractures for small seismic events in real-time.

There is an unmet need for a system capable of monitoring fracture orientation of each individual microseismic events, in real-time, as hydraulic fracturing operations occur.

There is a further unmet need for increasingly sensitive technologies which can identify the fracture orientation for small and previously undetectable microseismic events.

There is an ongoing need for data about previously undetected microseismic events and their polarity to advance scientific research.

### BRIEF SUMMARY OF THE INVENTION

The present invention is a system which includes instrumentation and processors which perform instructions to produce highly accurate focal mechanisms for small seismic events during fracking operations. In various embodiments, the invention transforms ground velocity signals into vectors through a cross correlation function. The values from these vectors are weighted and ranked. The result is input into a 3-D model to enhance interpretation of seismic events.

The method includes the steps of resolving relative P and S-wave polarities between pairs of waveforms using their signed correlation coefficients and performing a cluster analysis to group events with similar patterns of polarities across the network. The method further includes the step of applying a standard mechanism inversion to the grouped data, using either catalog or correlation-derived P-wave polarity datasets.

### BRIEF DESCRIPTION OF THE DRAWINGS

FIGS. 1a and 1b illustrate an exemplary process for determining polarity value of a small seismic event using previously catalogued P-wave and S-wave templates and the inverse of the templates.

FIGS. 2a and 2b illustrate an exemplary system process producing correlation coefficients with a specific time interval for a small seismic event.

FIG. 3 illustrates an exemplary system processes used for creating clusters of polarity values to identify the most consistent set of polarities for an entire population of small seismic events.

FIGS. 4a through 4d illustrate exemplary focal mechanisms for small seismic events produced using various composite methods.

FIGS. 5a and 5b illustrate two polarity observations of a cluster of earthquakes with differing levels of agreement between catalog and singular value decomposition derived polarities.

### TERMS OF ART

As used herein, the term “catalog matrix” means a two-dimensional array of locations and ground velocity data.

As used herein, the term “cross correlation function” means the relationship between two variables or signals that shows how similar they are to each other.

As used herein, the term “fault” means any indication of geologic instability to include but not limited to fault, crack, fissure, fracture, shear, opening, slip, or plate.

As used herein, the term “focal mechanism” data structure which stores three values for two possible faulting orientations: compass direction, orientations of slip, angle from horizontal.

As used herein, the term “ground velocity signal vector” (GVS) means a vector representing ground motion as recorded by a seismometer. This includes but is not limited to P-waves, S-waves and other surface and body waves.

As used herein, the term “hierarchical cluster” means groups of weighted polarity vectors with similar cosines that form a set.

As used herein, the term “time interval” means the duration of data capture.

As used herein, the term “interval pair” means two data vectors analyzed together.

As used herein, the term “largest maximum absolute value” means the highest peak within predetermined threshold limits after converting all data to a positive status.

As used herein, the term “location” means the placement of a device that receives a signal.

As used herein, the term “mathematically comparable” means grouped information according to wave type (e.g., S, P, or other) and within a threshold.

As used herein, the term “normalized cross correlation vector” (CCV) means a one-dimensional array containing ground velocity signal information on a scale of negative one to positive one.

As used herein, the term “object” refers to a processing component which binds to a microprocessor at run time to functions identically to the circuitry of a physical processor, and which transforms and configures the microprocessor to perform specialized functions. An object may contain data, data structures and functions, and may serve as an independent processing component within a server or system.

As used herein, the term “phase” means a S-wave or an S-wave.

As used herein, the term “polarity value” means the direction in which a wave travels either toward or away from a reference point and is expressed as either positive or negative respectively (a plus sign or a minus sign associated with wave information).

As used herein, the term “real time” means during a designated time period or session.

As used herein, the term “second largest maximum absolute value” means the second highest peak within predetermined threshold limits after converting all data to a positive status.

As used herein, the term “singular value decomposition” (SVD) means a mathematical computation that takes complex matrices and simplifies them to components that numerically depict a vector within a rotational plane.

As used herein, the term “threshold” means a cutoff parameter (ceiling) below which data is included for analysis.

As used herein, the term “vector” means a one-dimensional array.

As used herein, the term “waveform template” means a data filed that includes previously stored ground motion values obtained from seismic sensors from previous earthquakes.

As used herein, the term “weighted polarity” means information that is obtained when weighted relative polarities are transformed using singular value decomposition.

As used herein, the term “weighted relative polarities” (WRP) means cross correlation vector information that exceeds the threshold and are then compared and transformed to weighted polarities.

### DETAILED DESCRIPTION OF THE INVENTION

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “about,” “substantially” or “approximately” as used herein may be applied to modify any quantitative representation that could permissibly vary without resulting in a change in the basic function to which it is related.

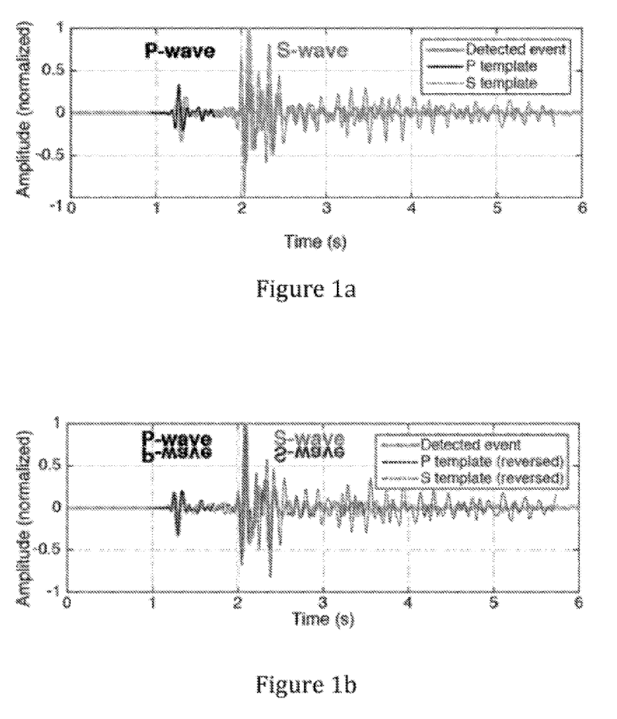

FIGS. 1a and 1b illustrate an exemplary process for determining polarity value of a small seismic event using previously catalogued P-wave and S-wave templates and the inverse of the templates.

The system receives as input P and S polarities for grouping of events with highly correlated waveforms in very close proximity. Waveform correlation accuracy decreases with increasing source separation distance. The system performs a P-wave first-motion focal mechanism performed on populations of seismic events with similar focal mechanisms. The system then applies hierarchical clustering to group events that have similar (P and S) polarity patterns across the network. Finally, system 100 reconciles the full set of relative polarity measurements.

Waveform template a, illustrates P wave and S wave polarity. Waveform template b illustrates the same waveforms, reversed in sign, according to the peak correlation values for P (c) and S (d).

Correlation coefficient for P-wave template c is a function of lag time, relative to the peak correlation sum across the full network. Correlation peak at about +0.8 s results from the P template correlating with the S waveforms of the detected event, but is outside the maximum lag time of 0.5 s. Waveform template d is the same as waveform template c, but for the S-wave template. Events are both located at ˜5.5 km depth, with centroid locations separated by ˜294 m.

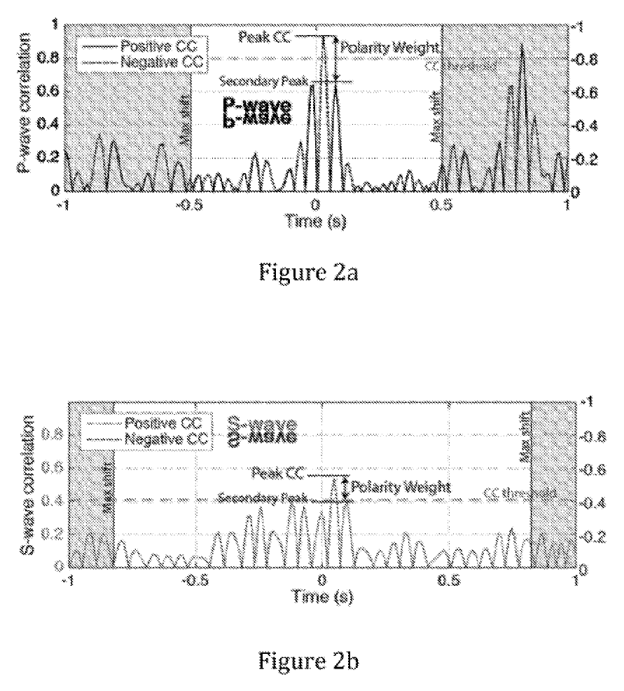

FIGS. 2a and 2b illustrate an exemplary system process producing correlation coefficients with a specific time interval for a small seismic event.

FIG. 2 is a schematic of an exemplary system for producing a weighted relative polarity measurement. The relative polarity times is the difference between the peak and the secondary peak, in an absolute value sense (a proxy for the relative confidence in this polarity), as illustrated in FIG. 1. In the exemplary embodiment shown, the secondary peak is separated from the main peak by at least 0.03 s.

The system receives as input a plurality of approximated relative polarity measurement associated event pairs and produces output that is a determination of the most consistent set of polarities for the entire population of events for a given station, channel, and phase (P or S).

In one exemplary embodiment, each template and each detected event has either “positive” or “negative” polarity on the given channel/phase. Thus, the pattern of relative polarities produced from each “positive” template across all detected events (ignoring the weight) would be the same, and the pattern of relative polarities from each “negative” template would be the exact opposite. The measurements are approximations. The large degree of redundancy in the measurements still enables the system to produce reliable measurements of polarity for extraction.

In various embodiments, the system utilizes a standardized protocol extracting this dominant signal based on the application of the singular value decomposition (SVD). Relative polarity measurements with larger weight influence the decomposition most strongly.

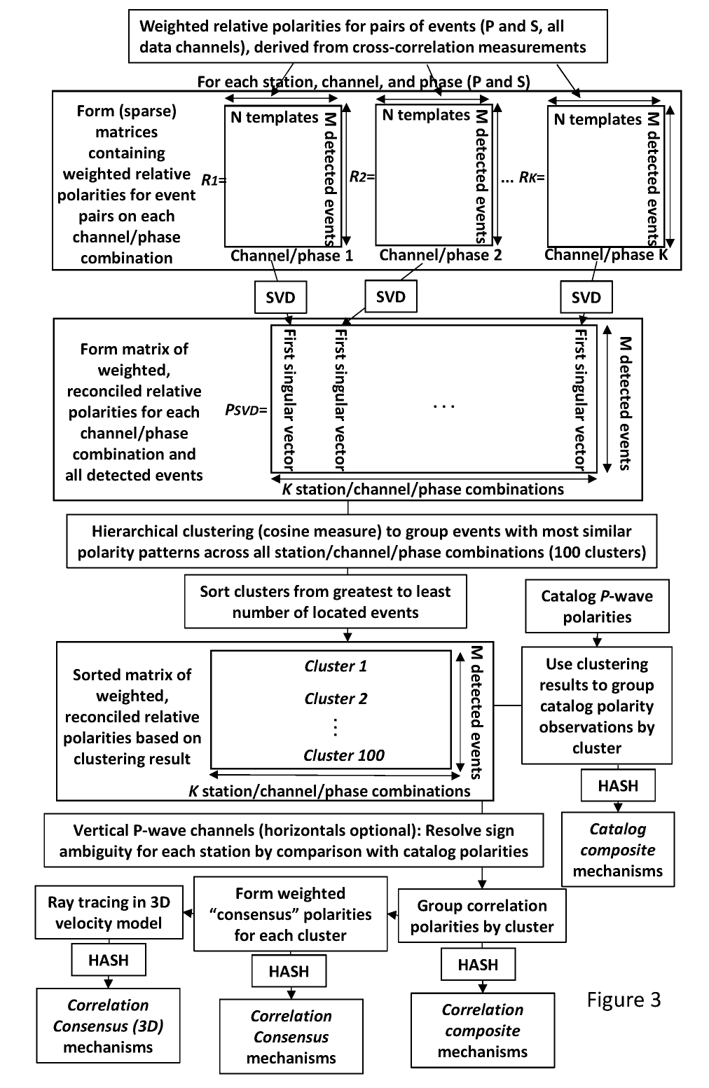

FIG. 3 illustrates an exemplary system process used for creating clusters of polarity values to identify the most consistent set of polarities for an entire population of small seismic events.

FIG. 3 illustrates the step of forming an n×m matrix R containing all of the relative polarity measurements between all templates (m) and all detected events (n), for a single data channel and phase (P or S). This step utilizes measurements from all detected events.

Consider an exemplary embodiment in which there are a total of 3105 templates (m), 27,140 total detected events (n), and 142 station/channel/phase combinations (k). A subset of 8,494 events with precise locations is isolated for further processing.

FIG. 3 further illustrates is the step of constructing a matrix of all weighted relative polarities (Rᵢ) for every available event pair, for a single station/channel/phase combination:

$${R}_{i} = [ \begin{matrix}{r}_{11} & … & {r}_{1 m} \\ ⋮ & ⋱ & ⋮ \\ {r}_{n 1} & … & {r}_{n m}\end{matrix} ]$$

where rows are all detected events, columns are all templates.

FIG. 3 also illustrates is the step of obtaining the SVD of this matrix and find the right singular vector (of length n) corresponding to the largest singular value.

In one exemplary embodiment (assuming the relative polarity measurements are accurate), the matrix includes only one non-zero singular value. The largest singular value and its corresponding vector provide a means of estimating the most consistent set of polarities (the signs the elements of the singular vector), as well as the relative confidence in that polarity (by their magnitudes) for each event for a given station, channel, and phase combination.

Mᵢ=SVD(Rᵢ)=UᵢΣᵢVᵢ^{T}

where U and V are the left and right matrices of singular vectors, respectively, and Σ is a diagonal matrix of singular values. Then, the most consistent set of polarities is contained within the first singular vector, v1ᵢ, with size n×1, for the ith station/channel/phase combination. This process is then repeated for all station/channel/phase combinations.

FIG. 3 further illustrates the step of using a cluster analysis to identify groups of events with similar polarity patterns across the network (P and S phases). Events are grouped based on similarity of patterns In preparation, a matrix is constructed with columns consisting of the (first) singular vectors from all channel/phase combinations, s, to make an n×k matrix.

$${P}_{SVD} = [ \begin{matrix}⋮ & … & ⋮ \\ v {1}_{1} & … & v {1}_{k} \\ ⋮ & … & ⋮\end{matrix} ]$$

This matrix contains weighted relative polarity estimates for each channel and phase, and for each detected event.

FIG. 3 further illustrates the step of applying a hierarchical clustering algorithm to this matrix, treating each channel/phase (column) as a variable and each event (row) as an observation—thereby grouping events with similar patterns of polarities. In one exemplary embodiment, a cosine is used measure of “distance” between an individual vector and the average for the cluster. For exemplary embodiment, the distance between row vectors A and B, their similarity is measured by the angle θ between them, as

$$similarity = cos θ = \frac{A \cdot B}{‖ A ‖ ‖ B ‖}$$

In one exemplary embodiment, results are obtained by cutting the hierarchical tree to obtain 100 total clusters, though the process is not highly sensitive to this number. In this exemplary embodiment, most clusters contain very few events, but we sort the clusters by the total number of located events within each and focus here on the most populous clusters.

FIG. 3 also illustrates the step of producing an estimation for each cluster from composite catalog P-wave polarities. Events are grouped into clusters with similar polarity patterns across the network. Each group consists of events with similar (but as yet unknown) mechanisms. In most embodiments, the relative polarity measurements in the mechanism estimation step are retained. Other embodiments may retain only the grouping established by the relative polarity analysis, or may otherwise revert to a traditional composite mechanism scheme, where the mechanism solutions themselves are derived solely from catalog polarity determinations. This embodiment may also be most appropriate in cases where a mechanism cluster is spatially isolated, with relatively few successful correlation measurements connecting it to other clusters.

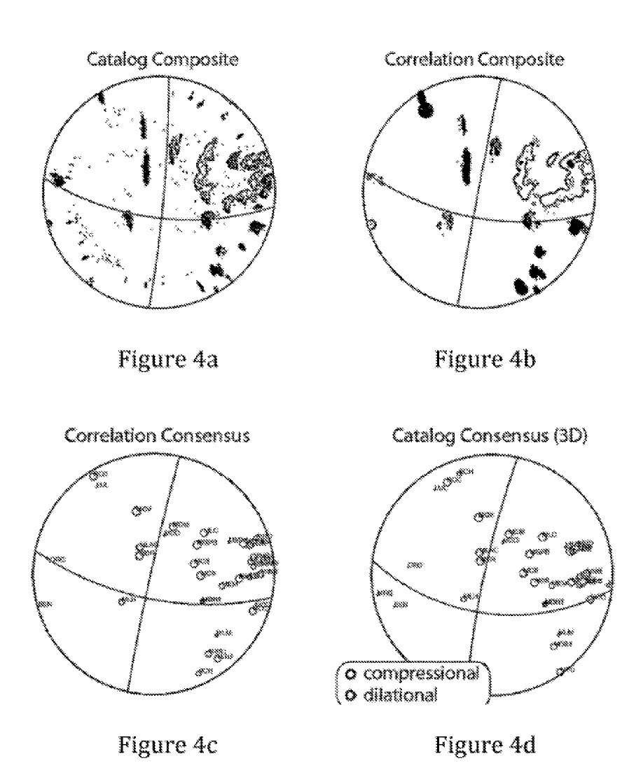

FIG. 4a illustrates an exemplary focal mechanism for small seismic events produced using a catalog composite method. In the exemplary embodiment shown, ray azimuths and take-off angles to each station are computed separately for each earthquake in a cluster, to account for differences in ray path due to location differences. All catalog polarity observations for a cluster are then used to constrain the composite focal mechanism. Stations with reversed polarity (based on metadata showing reversed orientation or negative gain) are accounted for at this step, because catalog polarity observations do not reflect this reversal.

In an alternative embodiment, a focal mechanism may be estimated directly from correlation-derived P-wave polarities. In this embodiment, catalog polarities are used solely for resolving the sign ambiguity of the correlation-derived polarities. In this embodiment, errors in catalog polarity determinations can be resolved by the correlation-derived relative polarities. In addition, this approach potentially requires only a small number of reliable absolute polarity determinations to resolve the sign ambiguity of the reconciled relative polarities.

In various embodiments, after reconciling relative polarity measurements for each station using the SVD, a sign ambiguity may remain. This ambiguity is resolved for P waves using the available routine catalog first-motion polarity picks.

In various embodiments, each station and component may utilize catalog polarity measurements and compute the final polarity weightings based on the relative agreement between catalog and correlation-derived polarities and whether correlation-derived polarities tend to have same of opposite signs.

In various embodiments, data points may be weighted by the product of the weighted SVD-derived polarity (polsvd) with the weight of the catalog phase pick, plotted as the horizontal and vertical axes (respectively). In the case where catalog phase picks include a weight (catwt) of 0 (best) to 4 (worst); we invert this weighting to give a larger numerical weight to the best observations, as:

wt=5−catwt

On exemplary weighted polarity factor (measuring consistency between catalog and correlation-derived polarities) for station k is:

wt_(catpol_k)=(Σ(wt·pol_svd))/(Σ|wt·pol_svd|)

This gives a normalized measure of the relative agreement between catalog and correlation-derived polarities, ranging from −1 (perfect agreement, opposite sign) to +1 (perfect agreement, same sign). Finally, each SVD-derived P-wave polarity is multiplied by the wtcatpol for that particular data channel. Thus, this weighting resolves the polarity ambiguity while also reflecting the relative confidence in that resolution (i.e. how well the catalog and correlation-derived polarities agree

FIG. 4b shows polarity observations of a cluster of seismic events using a correlation composite method.

FIG. 4c shows polarity observations of a cluster of seismic events using a correlation consensus method.

FIG. 4d shows polarity observations of a cluster of seismic events using a correlation consensus incorporating a 3-D seismic velocity model.

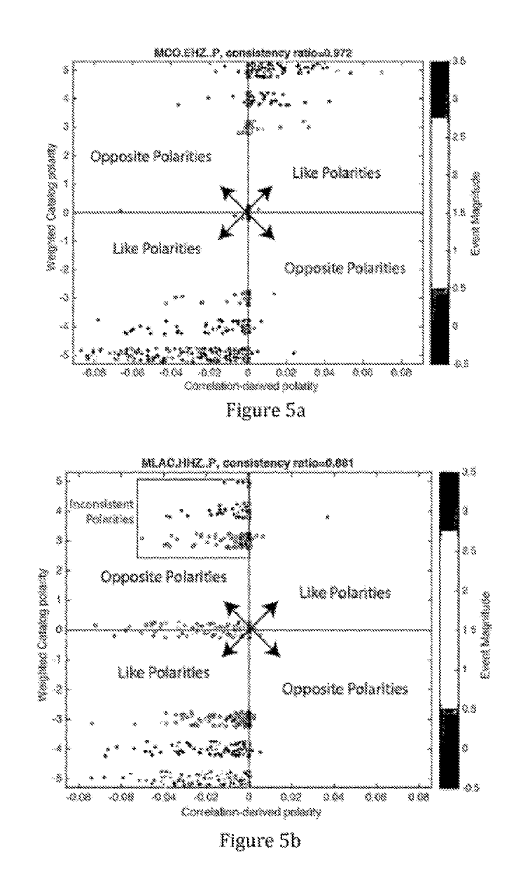

FIGS. 5a and 5b illustrate two polarity observations of a cluster of earthquakes with differing levels of agreement between catalog and singular value decomposition derived polarities.

In FIG. 5, consistent observations for a given data channel are those that fall entirely in either “like” or “opposite” quadrants (black arrows show consistent quadrant pairs). Points are colored by event magnitude. Filled circles are observations labeled in the catalog as “impulsive.” Zero catalog weight indicates no polarity pick given. Measurement confidence increases at greater distance from zero. Plotted position on the vertical axis is dithered slightly for visibility. In FIG. 5a, an example with mixed polarities shows excellent agreement between catalog and SVD-derived polarities. By comparison the example in FIG. 5b shows less strong agreement. Correlation-derived polarities are all negative—the relatively small number of positive catalog polarities (red box), most of which are designated as lower quality picks, may be in error.

What is claimed:

1. A computer system for producing a highly accurate focal mechanism for microseismic activity, wherein the system is comprised of:
a plurality of seismic event sensors;
a vector which stores plurality of ground velocity signal (GVS) values associated with signal waves received from each of said plurality of seismic event sensors during a time interval;
a Cross Correlation (CCV) Matrix Object which includes a CCV matrix and which performs functions to create to create a plurality of cross correlation vectors (CCVs) and to store a plurality of mathematically comparable CCVs in said CCV matrix;
a Weighted Relative Polarity (WRP) Matrix Object which stores WRP values for each of said CCVs in a WRP matrix;
a WP Matrix Object which includes a WP matrix and which performs a singular value decomposition function on said WRP matrix, to produce Weighted Polarity (WP) vectors associated with said time interval; and
and a 3-D model processing component which includes a value that is a polarity value from said catalogue object multiplied by a mathematically similar WP.

2. The system of claim 1 wherein said WRP is the difference between said largest maximum absolute value of the CCV and said second largest maximum absolute value of the CCV for each said time interval.

3. The system of claim 1 wherein said mathematically comparable CCVs are a subset of CCVs that have absolute values which exceed a threshold correlation coefficient for determining comparability of a new event and all previous events.

4. The system of claim 1 which further includes a processor which applies a hierarchical clustering algorithm to vectors said WP values and groups said weighted relative polarity into hierarchical clusters using a cosine distance measure.

5. The system of claim 1 wherein said signal wave pairs correspond to microseismic activity having a magnitude of less than 1

6. The system of claim 1 wherein said WRP matrix is populated with relative polarity values obtained by iteratively calculating the difference between a cross correlation vector with the largest maximum absolute value and a cross correlation vector with the second largest maximum absolute value to obtain said weighted relative polarity values.

7. The system of claim 1 wherein said WRP matrix includes WRP values upon which a singular value decomposition function has been performed.

8. The system of claim 1 wherein said WRP matrix includes weighted polarity vectors, wherein each of said weighted polarity values is associated with said interval.

9. The system of claim 1 which further includes an interface which displays 3-D images of estimated fault geometry.

10. The system of claim 1 which further includes a processor for updating wherein said 3-D images in real time.

11. The system of claim 1 wherein said GVS vector represents at least one S-wave.

12. The system of claim 1 wherein said GVS vector represent at least one P-waves.

13. The system of claim 1 wherein said second largest maximum absolute value is separated by said largest maximum absolute value by at least 0.03 seconds.

14. The system of claim 1 wherein said WRP matrix includes a plurality of weighted relative polarities (Rᵢ) for every available event pair, for a single seismic sensor and phase:
$${R}_{i} = [ \begin{matrix}{r}_{11} & … & {r}_{1 m} \\ ⋮ & ⋱ & ⋮ \\ {r}_{n 1} & … & {r}_{n m}\end{matrix} ]$$
where rows are all detected events, columns represent all template events.

15. The system of claim 1 which further includes a WRP matrix wherein said similar patterns of polarities that have been identified from rows of the matrix with columns consisting of the (first) singular vectors from all channel/phase combinations, s, to make an n×k matrix, as follows:
$${P}_{SVD} = [ \begin{matrix}⋮ & … & ⋮ \\ v {1}_{1} & … & v {1}_{k} \\ ⋮ & … & ⋮\end{matrix} ]$$
wherein said matrix then contains weighted polarity estimates for each detected event.

16. A method for producing a highly accurate focal mechanism for microseismic activity, comprised of the steps of:
receiving a plurality of catalogue phase data structures which includes a catalogue data representing recorded ground waveform templates of known earthquake activity, wherein each of said templates includes a P-wave polarity value;
receiving a plurality of ground velocity signal (GVS) values from seismic event sensors;
performing a cross correlation function to identify a plurality of mathematically comparable cross correlation vectors,
iteratively calculating the difference between largest maximum absolute value of said CCV and the second largest maximum absolute value of the CCV for each interval to obtain a plurality of weighted relative polarities corresponding to interval pairs;
populating a WRP matrix with said plurality weighted relative polarities values;
performing a singular value decomposition function on said WRP matrix, to produce a plurality weighted polarities (WP) as output;
storing said plurality of WP's as a vector;
associating each of said the WP's with an interval;
retrieving said polarity value from said catalog phase data structure;
multiplying said polarity value by said WP; and
replacing said catalog data with said WP in a 3-D model.

17. The Method of claim 16 which further includes the step of performing a signal-to-noise function by comparing each of said waveform templates with said seismic data obtained during a user defined session, wherein said normalized cross correlation function receives said GVS vectors for each said time interval as input and produces normalized cross correlation vectors as output.

18. The method of claim 16 wherein said singular value decomposition function is expressed as:
Mᵢ=SVD(Rᵢ)=UᵢΣᵢVᵢ^{T}
where U and V are the left and right matrices of singular vectors, respectively, and Σ is a diagonal matrix of singular values, and wherein the most consistent set of polarities is contained within a first singular vector, v1ᵢ, with size n×1, for the ith station/channel/phase combination.

19. The method of claim 16 which further includes the step of resolving the sign ambiguity of said P-wave correlation-derived polarities.

20. A real-time monitoring system for determining the polarity of microseismic fractures comprised of:
a plurality of seismic event sensors which detect activity after an induced seismic event;
a computer processor operatively coupled to said plurality of seismic sensors which includes:
a catalogue object which is populated with verified seismic events vector for a time window;
a virtual processing component which receives seismic data transforms said data into incoming seismic event vectors;
a filtering component which iteratively compares incoming seismic event vectors to verified seismic event vectors based on a cross correlation threshold and which updates said catalogue object to include verified nano-seismic event vectors having a magnitude of less than zero to produce an updated catalogue object; and a graphical user interface object which iteratively processes updated catalogue object data.

21. The real-time monitoring system of claim 20 wherein said nano-seismic vectors have a magnitude of less than negative one.

22. The real-time monitoring system of claim 20 wherein said nano-seismic vectors have a magnitude of less than negative two.

23. The system of claim 20 wherein said verified seismic event vectors are matrix objects which store a plurality of cross-correlation vectors associated with signal wave pairs.

24. The real-time monitoring system of claim 20 wherein the absolute values of each of said cross-correlation vectors exceed a threshold correlation coefficient for identifying mathematically similar cross-correlation vectors when comparing said new seismic event and a previously occurring event.

25. The real-time monitoring system of claim 20 wherein said catalogue object further includes one or more values which quantify one or more relationships between one of more of said verified micro-seismic event vector parameters a previously determined probable direction.

26. The real-time monitoring system of claim 20 which further includes a processing component wherein the parameters each of said incoming micro seismic vectors compared to the direction of one or more said verified seismic vectors and said verified micro seismic vectors and assigned said predictive direction value.

27. A system for producing improved focal mechanisms from previously catalogued seismic data wherein the system is comprised of:
a plurality of seismic event sensors which detect activity after an induced seismic event;
a computer processor operatively coupled to said plurality of seismic event sensors and configured to receive seismic data for new seismic events including a plurality of ground velocity (GVS) values; and
a matrix object which stores a plurality of cross-correlation vectors associated with signal wave pairs obtained verified seismic events, wherein the absolute values of each said cross-correlation vectors exceeds a cross-correlation threshold correlation coefficient for identifying mathematically similar cross-correlation vectors when comparing said new seismic event and a previously occurring event;

28. The system of claim 27, wherein a catalogue object is populated with verified seismic events vector for a time window;

29. The system of claim 27, which further includes a filtering component which iteratively compares incoming seismic event vectors to verified seismic event vectors based on said cross correlation threshold.

30. The system of claim 27 which further includes an updated said catalogue object which includes verified nano-seismic event vectors having a magnitude of less than zero produce an updated catalogue object.
